(19) United States
(12) Patent Application Publication
(10) Pub. No.: US 2017/0003890 A1
(43) Pub. Date: Jan. 5, 2017

(54) DEVICE, PROGRAM, RECORDING MEDIUM, AND METHOD FOR EXTENDING SERVICE LIFE OF MEMORY

(71) Applicant: FIXSTARS CORPORATION, Tokyo (JP)

(72) Inventors: Satoshi Yoneya, Tokyo (JP); Keishi Chikamura, Tokyo (JP)

(73) Assignee: FIXSTARS CORPORATION, Tokyo (JP)

(21) Appl. No.: 15/103,411

(22) PCT Filed: Nov. 11, 2014
(86) PCT No.: PCT/JP2014/079814

§ 371 Date: Sep. 19, 2016

(30) Foreign Application Priority Data
Dec. 12, 2013 (JP) 2013-256918

(51) Int. Cl. G06F 3/06

(52) U.S. Cl. CPC G06F 3/0616; G06F 3/0635; G06F 3/0659; G06F 3/0688; G06F 3/0653

(57) ABSTRACT

The problem addressed by the present invention is to provide a means for suppressing a drop in overall performance that occurs when data rewriting is concentrated in a specific memory in a data-processing system comprising a plurality of memories, in which a number of possible rewrites is limited. A data-processing system as in one embodiment of the present invention comprises a management device and a plurality of data-processing devices. Each data-processing device comprises a memory, which is a NAND flash memory. Each data-processing device transmits, to management device, status data indicating a number of data rewrites to memory of the host device. Management device allocates data processing to the data-processing device having the smallest number of data rewrites indicated by the received status data.

### TECHNICAL FIELD

The present invention pertains to a feature for extending a service life of a memory in which a number of times data can be rewritten is limited.

### BACKGROUND ART

A number of times that data can be rewritten to a memory is subject to limitations. For example, a number of times that each storage element can be rewritten to a 2-bit MLC (Multiple Level Cell) NAND flash memory, the use of which has become widespread, is in the order of tens of thousands in practice. The limitation in the number of times that data can be rewritten to a flash memory is due to a gradual deterioration of a tunnel oxide film in a flash memory under passage of electrons upon each write operation.

As noted, flash memory is subject to rewrite limitations. This is also the case for other types of memory such as compact disc-rewritable, CDRW, and Digital Versatile Disc rewritable DVDRW.

Since limitations exist on a number of times that data can be written to a memory, if writing and rewriting of data is concentrated within a specific storage region, there is a tendency for the specific storage region to become unusable at an early stage, even if the overall amount of data writes is no more than in a case where the data is written over multiple storage regions. When a storage region reaches its write capacity, overall storage capacity of a memory is reduced, with a consequent drop in performance.

Wear leveling is a technique for reducing the problem described above. FIGS. 12-14 provide an outline of the mechanism of wear leveling used in the prior art, using a NAND flash memory as an example. In a NAND flash memory, data is generally read/written in storage region units referred to as “pages,” and data is deleted from storage region units referred to as “blocks,” which are groups of adjacent pages. The NAND flash memory illustrated in FIG. 12 is provided with m number of blocks (blocks 1 to m), and each of blocks 1 to m is provided with n number of pages (pages 1 to n).

A memory controller that controls reading/writing of data in a NAND flash memory manages a memory management table such as that illustrated in FIG. 13. The memory management table is provided with, for each of the pages of the NAND flash memory, a “page ID” data field that stores data that identifies the page, a “status” data field that stores data that indicates the status of data storage of the page, and a “number of rewrites” data field that stores data that indicates the number of times the page has been rewritten. The “status” data field stores, for example, one of the following statuses: “not in-use,” which indicates the page is not holding data; “in-use,” which indicates the page is holding data that should be held; “deletable,” which indicates the page is holding data that may be deleted; and “defective,” which indicates that the page is deemed to be in a defective state for reasons such as an error having occurred in a page during reading/writing, causing the page to be unusable.

Further, the memory controller manages an address conversion table such as that illustrated in FIG. 14. An address conversion table is a table for converting an address into a page ID, the address being identification data used by a request source device that requests reading/writing of data to identify a storage region, and the page ID being identification data used to identify a storage region in a NAND flash memory. The address conversion table is provided with an “address” data field, which stores an address, and a “page ID” data field, which stores a page ID corresponding to the address. Hereafter, as an example, the page ID will follow the format “(block number)—(page number).”

For example, if the request source device instructs the memory controller to read data A stored in address “xxxx,” to process data A, and to write data A′ generated in the process to address “xxxx,” the memory controller performs the following process. Firstly, the memory controller specifies a page ID corresponding to address “xxxx” in accordance with the address conversion table (FIG. 14). Hereafter, as an example, page ID “1-4” is specified.

Next, the memory controller reads data A from page 4 of block 1 identified as page ID “1-4” and temporarily stores data A in a data buffer, before handing the data over to a processor. Next, the data buffer receives data A′ from the processor and temporarily stores the data, and then the writing destination of data A′ is selected in accordance with the memory management table (FIG. 13). When making the selection, the memory controller selects one page at random, for example, from among pages for which the “status” is not in use and the “number of rewrites” is the lowest. Hereafter, as an example, page 5 of block 2 identified as page ID “2-5” is selected.

Next, the memory controller writes data A′ to page 5 of block 2. Then, the memory controller performs updates of the memory management table (FIG. 13) and the address conversion table (FIG. 14) that are used in the foregoing process. Specifically, the memory controller initially changes the data field “status” of the data record corresponding to page ID “1-4” of the memory management table from “in-use” to “deletable.” The memory controller also changes the data field “status” of the data record corresponding to the page ID “2-5” of the memory management table from “not in-use” to “in-use,” and increases the value of the data field “number of rewrites” by one. Further, the memory controller changes the “page ID” data field of the data record corresponding to address “xxxx” of the address conversion table from “1-4” to “2-5.”

As described above, by causing the memory controller to write data to pages that have been rewritten fewer times than other pages when rewriting data, the number of times data is rewritten is evenly balanced across the pages. This completes the outline of the mechanism of wear levelling in the prior art.

JP2012-022725A can be given as an example of a document that discloses a feature pertaining to wear levelling. Proposed in JP2012-022725A is selective use of passive wear levelling in which physical address blocks that are not for rewriting are left as they are, and active wear levelling in which physical address blocks that are not for rewriting are also rewritten so as to even out the number of times rewriting is performed in all physical address blocks. This selection is made in accordance with predetermined conditions. JP2012-022725A indicates that, by adoption of said feature, desired wear levelling is realized in a state in which data that contains a mix of data regions in which rewriting is performed often and data regions in which rewriting is seldom performed are written to a memory.

In recent years there has been a proliferation of systems comprising a large number of data storage devices provided with NAND flash memories or the like, to which memories the number of times data can be rewritten is limited. One example thereof is a system (hereafter referred to as “multi-node computer system”) that integrates a large number of computers (hereafter referred to as “node computers”), which are capable of data communication with other devices via a network, for example. The multi-node computer system takes the form of a shelf (rack) wherein r number of housings (chassis) in which q number of bases (cards) having p number of node computers arranged therein, are stacked, for example. In such a case, the multi-node computer system is provided with a total of (p×q×r) node computers. The node computers are capable of data communication with one another via a network that complies with a universal communication standard such as an Ethernet (registered trademark). In such node computers, increasingly, a memory that can only be rewritten a limited number of times, such as a NAND flash memory, is used.

If data processing that involves data rewriting is performed in a concentrated manner by specific node computers in a multi-node computer system that integrates a large number of node computers provided with memories that can only be rewritten a limited number of times, such as that described above, the memories of the specific node computers become unusable at an earlier stage than the memories of other node computers, whereby the performance of the specific node computers drops. As a result, the overall performance of the multi-node computer system declines.

### SUMMARY

The present invention was achieved in view of the background described above, and has a purpose of providing a means for suppressing a drop in overall performance of the system that occurs due to data rewriting being concentrated in specific memories in a data-processing system provided with a plurality of memories that can only be rewritten a limited number of times.

To solve the above-described problem of the prior art, according to one aspect of the present invention, there is provided a device comprising: a status acquisition unit that acquires, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing devices; a request acquisition unit that acquires a data processing request that involves data rewriting; a selection unit that selects a single data-processing device from the plurality of data-processing devices, in accordance with predetermined rules and based on the status data acquired by the status acquisition unit from each of the data-processing devices; and an output unit that outputs, to the single data-processing device selected by the selection unit, the data processing request acquired by the request acquisition unit.

In the above-described device, a configuration may be adopted wherein the selection unit selects a source data-processing device and a destination data-processing device in accordance with predetermined rules and based on the status data acquired by the status acquisition unit from each of the plurality of data-processing devices; and the output unit outputs, to the source data-processing device and/or destination data-processing device selected by the selection unit, a request to move data from the source data-processing device to the destination data-processing device.

The present invention also provides, as one mode thereof, a device comprising: a memory; a memory controller that controls data reading/writing in the memory, and that generates status data indicating a status of the memory, including a number of data rewrites to the memory; an output unit that outputs, to a single device, the status data generated by the memory controller; an acquisition unit that acquires, from the single device, a data processing request that involves data rewriting to the memory; and a processor that performs data processing in response to the data processing request acquired by the acquisition unit.

The present invention also provides, as one mode thereof, a device comprising: a status acquisition unit that acquires, from each of a plurality of data storage devices comprising a memory, and a memory controller that controls reading/writing of data in the memory and that generates status data indicating a status of the memory, including a number of data rewrites to the memory, the status data generated by the memory controller of each of the plurality of data storage devices; a request acquisition unit that acquires a data rewrite processing request; a selection unit that selects a single data storage device from among the plurality of data storage devices, in accordance with predetermined rules and based on the status data acquired by the status acquisition unit from each of the plurality of data storage devices; and an output unit that outputs, to the single data storage device selected by the selection unit, the data rewrite processing request acquired by the request acquisition unit.

The present invention also provides, as one mode thereof, a device comprising: a memory; a memory controller that controls reading/writing of data in the memory, and that generates status data indicating a status of the memory, including a number of data rewrites in the memory; an output unit that outputs the status data generated by the memory controller to a single device; and an acquisition unit that acquires a data rewrite processing request from the single device; wherein the memory controller causes data rewrite processing to be performed on the memory in response to the data rewrite processing request acquired by the acquisition unit.

In the above-described device, a configuration may be adopted wherein: if the memory controller causes data rewrite processing to be performed on the memory, the memory controller selects a single storage region from a plurality of storage regions of the memory, in accordance with predetermined rules and based on the status data, and the memory controller causes the data rewrite processing to be performed on the single storage region of the memory.

The present invention also provides, as one mode thereof, a device comprising: a plurality of memories; a plurality of memory controllers, each of which is provided so as to correspond to one of the plurality of memories, controls reading/writing of data in the corresponding memory, and generates status data indicating a status of the corresponding memory including a number of data rewrites in the corresponding memory; an acquisition unit that acquires a data rewrite processing request; and a selection unit that selects a single memory from the plurality of memories in accordance with predetermined rules and based on the status data generated by each of the plurality of memory controllers; wherein the memory controller corresponding to the single memory selected by the selection unit causes data rewrite processing corresponding to the data rewrite processing request acquired by the acquisition unit to be performed on the single memory.

In the above-described device, a configuration may be adopted wherein if each of the plurality of memory controllers causes data rewrite processing to be performed on the memory corresponding to the memory controller, the memory controller selects a single storage region from among a plurality of storage regions of the corresponding memory in accordance with predetermined rules and based on the status data generated by the memory controller, and each of the plurality of memory controllers causes the data rewrite processing to be performed on the single storage region of the corresponding memory.

The present invention also provides, as one mode thereof, a program for causing a computer to perform: a process for acquiring, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing device; a process for acquiring a data processing request that involves data rewriting; a process for selecting a single data-processing device from among the plurality of data-processing devices, in accordance with predetermined rules and based on the status data acquired from each of the plurality of data-processing devices; and a process for outputting the data processing request to the single data-processing device.

The present invention also provides, as one mode thereof, a program for causing a computer to perform: a process for acquiring, from each of a plurality of data storage devices comprising a memory, a memory controller that controls data reading/writing in the memory and that generates status data indicating a status of the memory including a number of data rewrites to the memory, the status data generated by the memory controller of the data storage device; a process for acquiring a data rewrite processing request; a process for selecting a single data storage device from among the plurality of data storage devices, in accordance with predetermined rules and based on the status data acquired from each of the plurality of data storage devices; and a process for outputting the data rewrite processing request to the single data storage device.

The present invention provides, as one mode thereof, a computer-readable recording medium on which the above-described program is permanently recorded.

The present invention also provides, as one mode thereof, a method comprising: a step in which a single device acquires, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing device; a step in which the single device acquires a data processing request that involves data rewriting; a step in which the single device selects a single data-processing device from among the plurality of data-processing devices, in accordance with predetermined rules and based on the status data acquired from each of the plurality of data-processing devices; and a step in which the single device outputs the data processing request to the single data-processing device.

The present invention also provides, as one mode thereof, a method comprising: a step in which a single device acquires, from each of a plurality of data storage devices comprising a memory, and a memory controller that controls data reading/writing in the memory and that generates status data indicating a status of the memory including a number of data rewrites to the memory, the status data generated by the memory controller of the data storage device; a step in which the single device acquires a data rewrite processing request; a step in which the single device selects a single data storage device from among the plurality of data storage devices, in accordance with predetermined rules and based on the status data acquired from each of the plurality of data storage devices; and a step in which the single device outputs the data rewrite processing request to the single data storage device.

According to the present invention, data rewrite processing or data processing that involves data rewriting is assigned to a plurality of data-processing devices or a plurality of data storage devices based on a number of data rewrites in a memory provided to each of a plurality of data-processing devices or data storage devices, enabling data rewriting to be performed evenly across a plurality of memories. As a result, there is a reduced incidence of occurrences of a problem in which one memory becomes unusable at an earlier stage than other memories. As a consequence, a drop in the overall performance of the system is minimized

### BRIEF EXPLANATION OF THE DRAWINGS

FIG. 1 is an external view of hardware of a data-processing system according to one embodiment.

FIG. 2 is a block diagram illustrating a hardware configuration of a data-processing system according to one embodiment.

FIG. 3 is a block diagram illustrating a functional configuration of a data-processing system according to one embodiment.

FIG. 4 is a drawing illustrating an example of a configuration of data of a node-unit memory management table according to one embodiment.

FIG. 5 is a drawing illustrating an example of a configuration of data of a file management table according to one embodiment.

FIG. 6 is a block diagram illustrating a hardware configuration of a data-processing system according to a modified example.

FIG. 7 is a block diagram illustrating a functional configuration of a data-processing system according to a modified example

FIG. 8 is a block diagram illustrating a hardware configuration of a data-processing system according to a modified example.

FIG. 9 is a block diagram illustrating a functional configuration of a data-processing system according to a modified example.

FIG. 10 is a block diagram illustrating a configuration of a data-processing system according to a modified example.

FIG. 11 is a block diagram illustrating a configuration of a data-processing system according to a modified example.

FIG. 12 is a drawing showing an overview of a mechanism of wear levelling of the prior art.

FIG. 13 is a drawing illustrating an example of a configuration of data of a memory management table used in wear levelling in the prior art.

FIG. 14 is a drawing illustrating an example of a configuration of data of an address conversion table used in wear levelling in the prior art.

### DETAILED DESCRIPTION

### First Embodiment

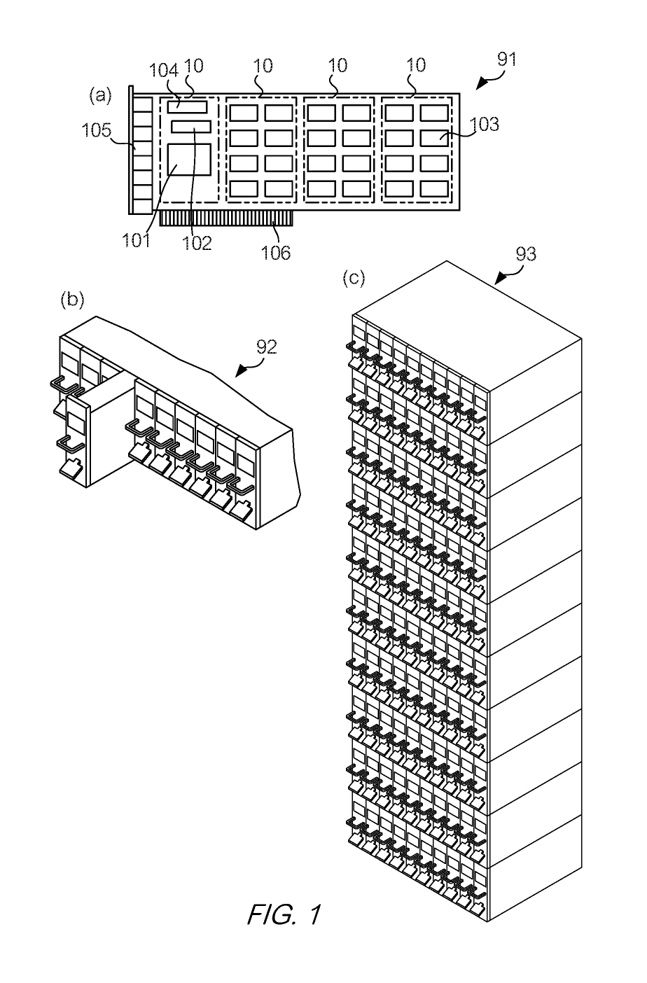

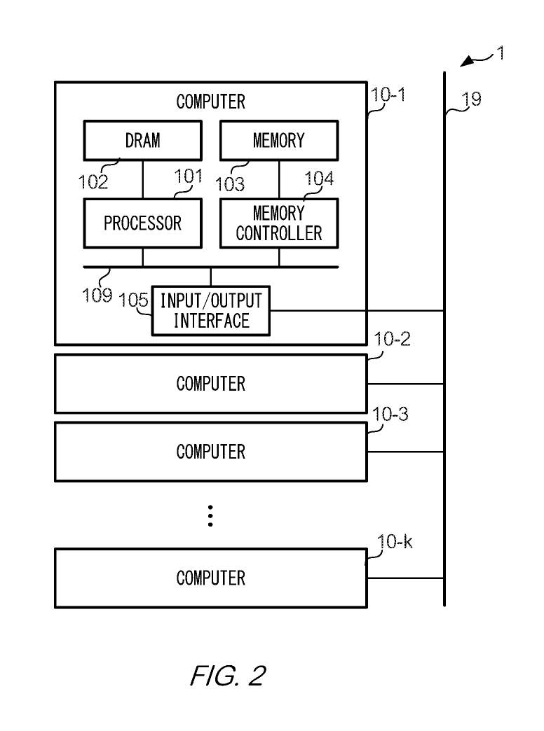

A data-processing system 1 as in one embodiment of the present invention is explained below. FIG. 1 is an external view of hardware of data-processing system 1. FIG. 2 is a block diagram illustrating a hardware configuration of data-processing system 1.

FIG. 1(a) shows the exterior of a card 91, in which four computers 10 are positioned. In FIG. 1(a), computer 10 positioned furthest to the left is shown with the memory module, normally positioned on the surface, removed. Each computer 10 comprises a processor 101 such as a CPU, which performs ordinary arithmetic operations, a DRAM 102 that is used by processor 101 as a main storage device, a memory 103 that is used by processor 101 as an auxiliary storage device, a memory controller 104 that is a processor that controls memory 103, and an input/output interface 105 that acquires data from and outputs data to other devices. In the present embodiment, input/output interface 105 is a communication interface that transmits and receives data to/from other devices over a network 19.

In each computer 10 exemplified in FIG. 1(a), processor 101 comprises two processor cores that are positioned one on the front surface and one on the rear surface of card 91. Memory 103 comprises 8 NAND flash memory modules positioned on the front surface and 8 NAND flash memory modules positioned on the rear surface of card 91 (making a total of 16 modules). The terminal group 106 shown in FIG. 1(a) is used to supply power to processor 101 and other components of computer 10.

Processor 101, memory controller 104, and input/output interface 105 are connected to one another by a bus 109. DRAM 102 is connected to processor 101, and memory 103 is connected to memory controller 104.

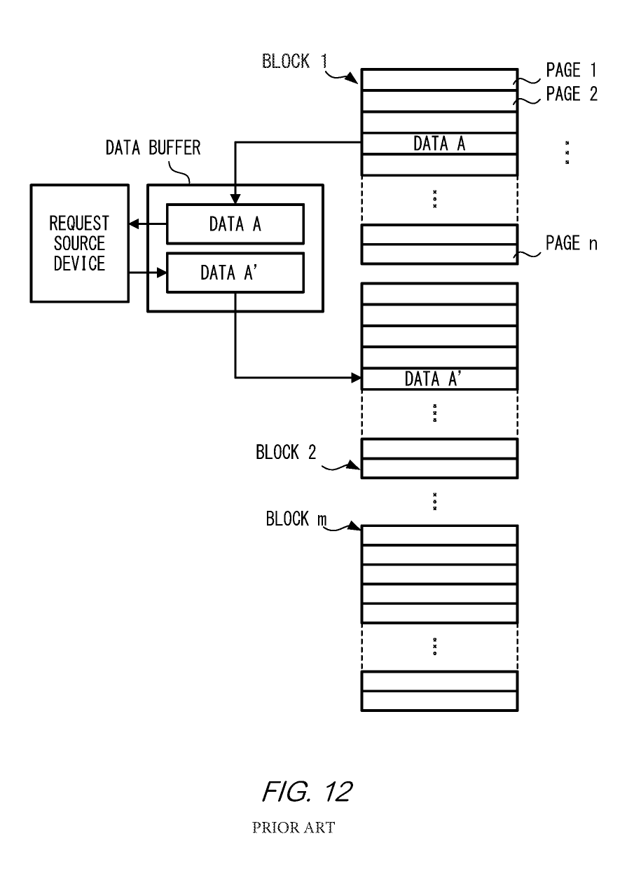

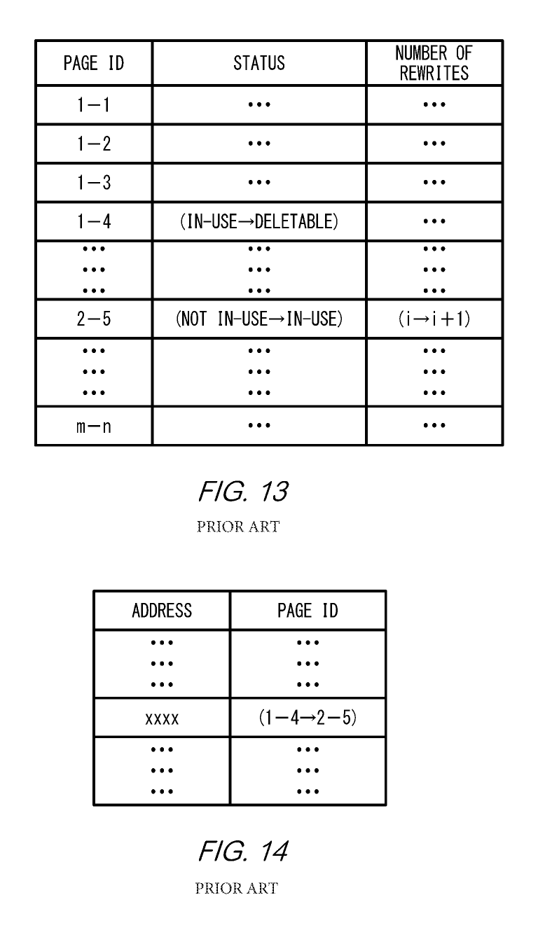

Memory controller 104 performs wear levelling in the same way as in the prior art, as shown in FIGS. 12-14. That is, memory controller 104 manages the memory management table (FIG. 13) and the address conversion table (FIG. 14) pertaining to memory 103 of the same computer 10, and uses these tables to perform wear levelling on memory 103 of the same computer 10.

FIG. 1(b) shows the exterior of a chassis 92 in which 10 cases having cards 91 housed therein are positioned horizontally. The number of cards 91 housed in a single case may be one or more than one. FIG. 1(c) shows the exterior of a rack 93 in which 10 chassis 92 are stacked vertically. Rack 93 constitutes the entire hardware of data-processing system 1. For example, if there are two cards 91 positioned in each of the cases that constitutes a single chassis 92, this means that data-processing system 1 comprises a total of 800 (4×2×10×10=800) computers 10.

Hereafter, to discriminate between the k (where k is a natural number) computers 10 provided to data-processing system 1, branch numbers computer 10-1, computer 10-2 . . . computer 10-k have been assigned, as shown in FIG. 2.

In data-processing system 1, of the k computers 10, one computer 10 serves as management device 11 that performs management to even out the number of memory rewrites in the other computers 10 of data-processing system 1. Meanwhile, computers 10 other than management device 11 serve as data-processing devices 12 that perform different types of data processing. Hereafter, computer 10-1 shall be deemed to serve as management device 11. Therefore, computer 10-2, computer 10-3 . . . computer 10-k serve as data-processing devices 12. To discriminate between the (k-1) data-processing devices 12, the same branch numbers as those used for the computers are assigned, namely data-processing device 12-2, data-processing device 12-3 . . . data-processing device 12-k.

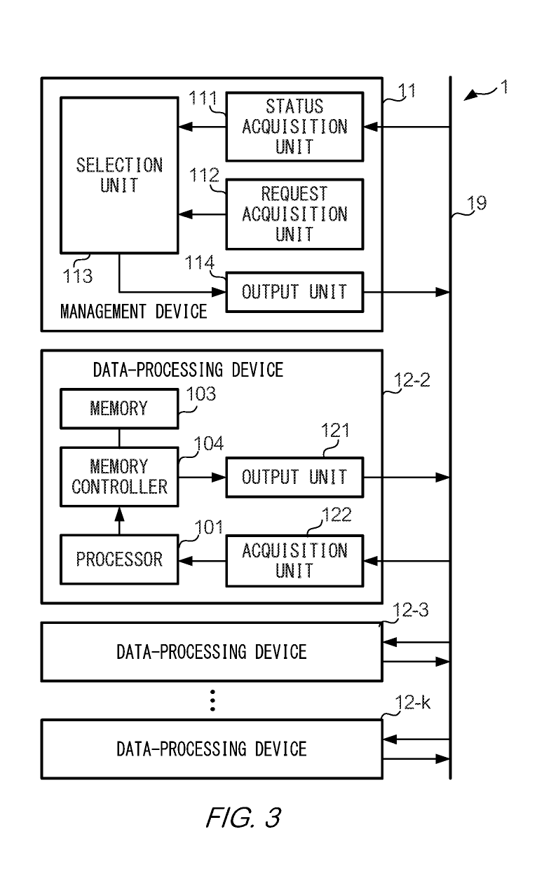

FIG. 3 is a block diagram illustrating the functional configuration of data-processing system 1. Computer 10-1 functions as management device 11 comprising status acquisition unit 111, request acquisition unit 112, selection unit 113 and output unit 114 by executing processing in accordance with a management device program stored on memory 103 of computer 10-1.

Each of computers 10-2 to 10-k functions as a data-processing device 12 comprising an output unit 121 and an acquisition unit 122 by performing processing in accordance with a data-processing device program stored in memory 103 of each of the computers. In FIG. 3 only the functional configuration of data-processing device 12-2 is shown, but the functional configuration of data-processing devices 12-3 to 12-k is the same. In addition, in FIG. 3, the functional configuration of data-processing device 12 is illustrated together with processor 101, memory 103, and memory controller 104 shown in FIG. 2 to show the relationship with the hardware configuration.

The functional configuration of data-processing device 12 is explained below. Output unit 121 outputs, to management device 11, status data generated by memory controller 104. Status data indicates the status of memory 103, and indicates at least a number of data rewrites to memory 103. In the present embodiment, in addition to the number of data rewrites to memory 103, status data indicates the number of data read/write errors in memory 103. A specific example of the procedure by which the memory controller 104 generates status data is explained below.

Memory controller 104 has stored therein a number of possible data rewrites indicating the number of times each storage element of memory 103 can be rewritten. At a predetermined timing (for example, the timing at which memory management table (FIG. 13) is updated, or the timing at which a predetermined time interval elapses), memory controller 104 divides the average value (average number of rewrites) of the “number of rewrites” for pages that are not shown as having a “defective” “status” in the memory management table by the number of possible rewrites indicated by the number of possible data rewrites, to calculate the average rewrite rate. This average rewrite rate is one example of an indicator of the number of times data has been rewritten to memory 103.

Memory controller 104 divides the number of pages having a “defective” “status” indicated by the memory management table by the total number of pages to calculate the defective page rate. This defective page rate is one example of an indicator that indicates the level of data read/write errors in memory 103. Memory controller 104 generates, as status data, data showing the average rewrite rate and defective page rate calculated as described above.

Output unit 121 outputs, to management device 11, status data generated by memory controller 104.

Acquisition unit 122 acquires data processing requests that are transmitted irregularly from management device 11. In some cases, the data processing that is the subject of the request acquired by the acquisition unit 122 involves data rewriting to memory 103. Processor 101 performs the requested data processing in response to the request acquired by acquisition unit 122. Processor 101 commands memory controller 104 to perform data rewriting in memory 103 as necessary, in conjunction with the data processing performed in response to the request. Memory controller 104, in accordance with this command, causes memory 103 to perform data rewriting, and updates the memory management table. When memory controller 104 causes memory 103 to perform a data rewrite, memory controller 104 performs the same wear levelling process as in the prior art, as described above.

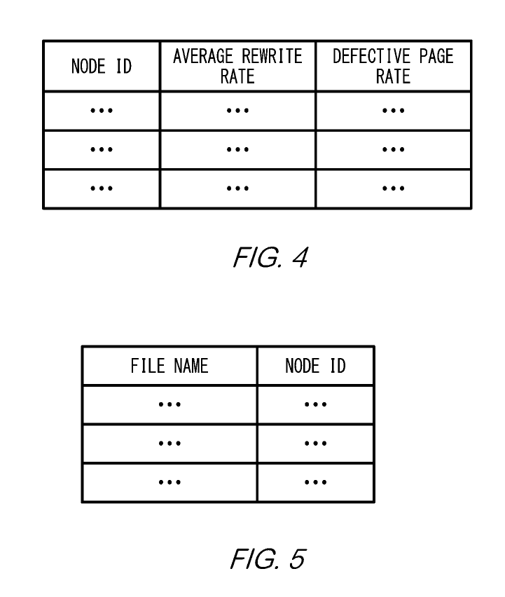

The functional configuration of management device 11 is explained next. Status acquisition unit 111 acquires status data outputted from each data-processing device 12. A node-unit memory management table that manages status data acquired by status acquisition unit 111 is stored in memory 103. FIG. 4 is a drawing illustrating a configuration example of data in the node-unit memory management table. The node-unit memory management table is a collection of data records corresponding to each data-processing device 12, and each data record has a “node ID” data field that stores the node ID, the node ID being identification data that identifies each of the data-processing devices 12, an “average rewrite rate” data field that stores the average rewrite rate, shown in status data acquired from data-processing device 12, and a “defective page rate” data field that stores a defective page rate shown in status data acquired from data-processing device 12. The node-unit memory management table is updated with newly acquired status data each time new status data is acquired by status acquisition unit 111.

Request acquisition unit 112 acquires a data processing request. The data processing request acquired by request acquisition unit 112 may be, for example: requests generated as a result of processing by processor 101 of the management device 11 in accordance with the program stored in memory 103; requests output from one of data-processing devices 12 to management device 11; and requests output to management device 11 from a device other than management device 11 or data-processing device 12.

When request acquisition unit 112 acquires a data-processing request that involves data rewriting, selection unit 113 selects, from among a plurality of data-processing devices 12, data-processing device 12 to perform requested data processing, in accordance with predetermined rules and on the basis of status data acquired by status acquisition unit 111 from each of a plurality of data-processing devices 12.

A specific example of the process employed by the selection unit 113 to select the data-processing device 12 that performs the requested data processing is explained below. Selection unit 113 reads the node-unit memory management table (FIG. 4) from memory 103, and uses data contained in the node-unit memory management table to calculate a deterioration indicator that indicates the degree of deterioration in memory 103 for each data-processing device 12. Formula 1 shown below is one example of the formula used for calculating the deterioration indicator. In the formula, dᵢ, is defined as the deterioration indicator for data-processing device 12-i, wᵢ, is the average rewrite rate shown in status data for data-processing device 12-i, and eᵢ, is the defective page rate shown in status data for data-processing device 12-i.

[Formula 1]

dᵢ=wᵢ×(1+eᵢ×1000) (Formula 1)

Selection unit 113 selects, as the data-processing device 12 that will execute the requested data processing, the data-processing device 12 having the smallest deterioration indicator calculated as described above.

Output unit 114 outputs, to data-processing device 12 selected by selection unit 113, a data-processing request acquired by request acquisition unit 112.

One type of data processing that is the target of the request acquired by request acquisition unit 112 is data processing of a type that uses data already stored in memory 103 of one of data-processing devices 12. To cause data-processing device 12 selected by selection unit 113 to perform such a type of data processing, output unit 114 includes, in the data processing request, the node ID to identify the data-processing device 12 storing data required for said data processing, and subsequently outputs said request.

For output unit 114 to specify the node ID to be included in the request to be output, a file management table having a configuration such as that shown in FIG. 5 is stored in memory 103. A file management table is a collection of data records corresponding to a file, and each data record has a “file name” data field that stores text data indicating a file name for identifying a file, and a “node ID” data field that stores the node ID that identifies the data-processing device 12 storing the file. Output

unit 114 specifies, in accordance with the file management table, the node ID of the data-processing device 12 storing data to be used in data processing, and after including the specified node ID in the data processing request together with the file name, outputs said request to the data-processing device 12 selected by selection unit 113.

Data processing system 1 has been explained above. Data processing system 1 can be used, for example, as a structure that sequentially assigns each of a series of data-processing tasks in accordance with a single application program to one of a plurality of data-processing devices 12, thereby performing said series of data processing tasks rapidly as a whole. For example, if an application program for 3D video editing in data-processing system 1 is executed, data processing in which the processing capacity required for rendering and the like is high, and the required memory capacity is great, the data-processing is divided up and carried out by a plurality of data-processing devices 12. As a consequence, in comparison, for example, to the same data processing carried out by a single computer, data processing is carried out at an extremely high speed. During this process, in addition to wear levelling in memory 103 of each data-processing device 12, wear levelling is also carried out across data-processing devices 12; thus, data processing that involves data rewriting is not concentrated in a specific data-processing device 12, and there is no possibility of a problem occurring in which memory 103 of a specific data-processing device 12 becomes unusable at an earlier stage than memory 103 of other data-processing devices 12. As a result, the high performance of data-processing system 1 can be maintained over a long period of time.

### Second Embodiment

A data-processing system 2 as in a modified example of the present invention is explained below. The configuration of data-processing system 2 is the same in many regards as the configuration of data-processing system 1 as in the first embodiment. The explanation below will focus on the parts of the configuration of data-processing system 2 that differ from the configuration of data-processing system 1, and explanation of the parts of the configuration that are shared with the configuration of data-processing system 1 will be omitted as necessary. Those components of data-processing system 2 that are the same as or that correspond to the components of data-processing system 1 are assigned the same reference symbols as those used in the explanation of data-processing system 1.

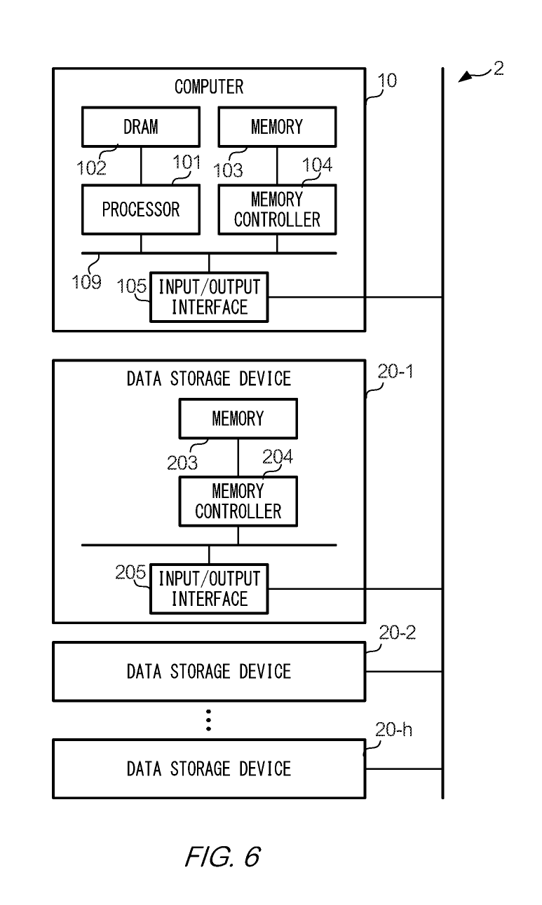

FIG. 6 is a drawing illustrating the hardware configuration of data-processing system 2. Data processing system 2 comprises a computer 10 and h (where h is a natural number of 2 or more) data storage devices 20 (data storage devices 20-1 to 20-h). The h data storage devices 20 may be constituted as individual devices separately, or as a part of or as the entirety of a single device.

The configuration of the computer 10 provided to data-processing system 2 is the same as the configuration of the computer 10 provided to data-processing system 1. Each data storage device 20 comprises a memory 203, a memory controller 204 that controls reading/writing of data from/to memory 203, and an input/output interface 205, which performs input/output of different types of data between computer 10 and data storage device 20.

Memory controller 204 is connected between memory 203 and input/output interface 205, and performs data read/write from/to memory 203 in response to data read/write requests acquired by input/output interface 205. Memory controller 204 performs wear levelling similar to that of the prior art when rewriting data to memory 203. In addition, memory controller 204 generates status data pertaining to memory 203, in the same way as memory controller 104 of data-processing device 12 in data-processing system 1.

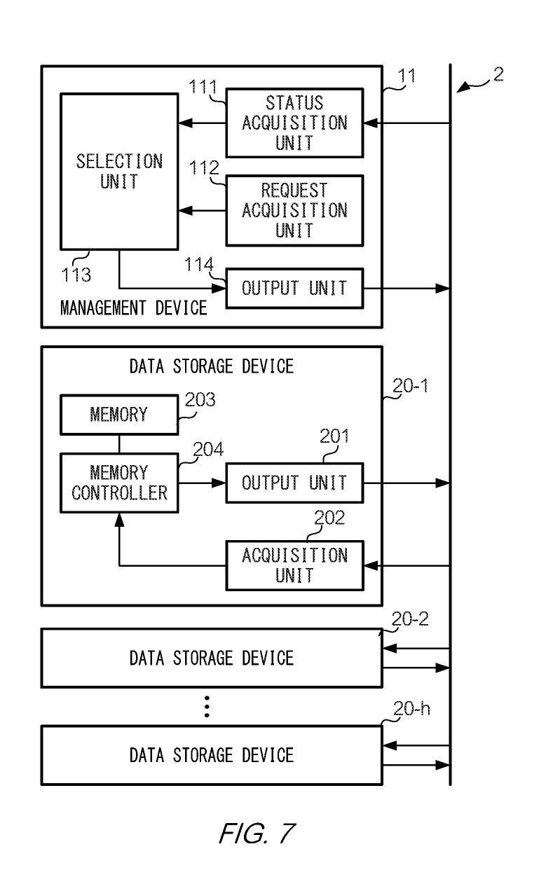

FIG. 7 is a block diagram illustrating the functional configuration of data-processing system 2. Computer 10 functions as a management device comprising a status acquisition unit 111, a request acquisition unit 112, a selection unit 113, and an output unit 114 by performing processing corresponding to a program for management device stored in memory 103. In data-processing system 2, the data processing request acquired by request acquisition unit 112 is a data rewrite processing request. Therefore, in data-processing system 2, selection unit 113 selects, from among a plurality of data storage devices 20, the data storage device 20 to execute data rewriting that is the subject of the request acquired by request acquisition unit 112. The procedure by which selection unit 113 selects data storage device 20 in data-processing system 2 is the same as the procedure by which selection unit 113 selects the data-processing device in data-processing system 1. In data-processing system 2, output unit 114 outputs, to data storage device 20 selected by selection unit 113, a request acquired by request acquisition unit 112.

Data storage device 20 functions as an output unit 201 and an acquisition unit 202 by executing processing in accordance with a program stored in an EPROM or the like provided to memory controller 204, for example. Output unit 201 outputs, to management device 11, status data generated by memory controller 204. Acquisition unit 202 acquires data rewrite processing requests output irregularly by management device 11. Memory controller 204 executes data rewriting to memory 203 in response to a request acquired by acquisition unit 202.

According to data-processing system 2, computer 10 can use memory 203 provided to the plurality of data storage devices 20 as an external storage device. When data rewriting is performed in an external storage device comprising a plurality of data storage devices 20, in addition to wear levelling between memory 203 of individual data storage devices 20, wear levelling is also carried out between data storage devices 20, thus data rewriting is not concentrated in a specific data storage device 20, avoiding the problem in which memory 203 of a specific data storage device 20 becomes unusable earlier than memory 203 of other data storage devices 20. As a result, the high performance of data-processing system 2 can be maintained for a long period of time.

### Third Embodiment

A data-processing system 3 as in a modified example of the present invention is explained below. The configuration of data-processing system 3 is the same in many regards as the configuration of data-processing system 1 of the first embodiment. The explanation below will focus on the parts of the configuration of data-processing system 3 that differ from the configuration of data-processing system 1, and explanation of the parts of the configuration that are shared with the configuration of data-processing system 1 will be omitted as necessary. Those components of data-processing system 3 that are the same as or correspond to the components of data-processing system 1 are assigned the same reference symbols as those used in the explanation of data-processing system 1.

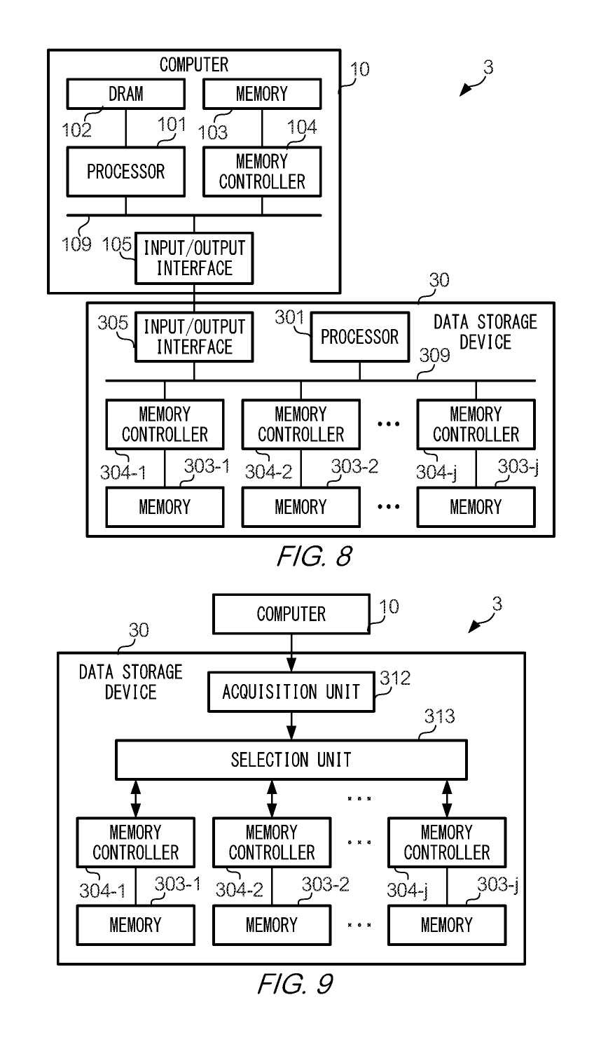

FIG. 8 is a drawing illustrating the hardware configuration of data-processing system 3. Data processing system 3 comprises computer 10 and data storage device 30.

The configuration of computer 10 provided to data-processing system 3 is the same as the configuration of computer 10 provided to data-processing system 1. Data storage device 30 comprises: j (where j is a natural number of 2 or more) memories 303 (memories 303-1-303-j); a plurality of memory controllers 304 (memory controllers 304-1 to 304-j), which are provided so as to correspond to each of memories 303, and which control data reading/writing from/to the corresponding memories 303, a processor 301 that performs data processing for wear levelling between the plurality of memories 303; and an input/output interface 305 that performs input and output of different types of data to/from computer 10. Processor 301, each memory controller 304, and input/output interface 305 are connected to one another via a bus 309.

In response to read/write requests for data generated by processor 301, each memory controller 304 has corresponding memory 303 perform reading/writing of data. When rewriting data to the corresponding memory 303, each memory controller 304 performs wear levelling in the same way as in the prior art. In addition, each memory controller 304 generates status data pertaining to corresponding memory 303, in the same way as memory controller 104 of data-processing device 12 in data-processing system 1.

FIG. 9 is a block diagram illustrating the functional configuration of data-processing system 3. However, in data-processing system 3, computer 10 operates as an ordinary computer, outputting read/write requests for data to data storage device 30, which involves a process corresponding to an arbitrarily-defined program stored in memory 103, for example.

By executing data processing in accordance with a program stored on EPROM or the like provided to processor 301, for example, data storage device 30 functions as an acquisition unit 312 and a selection unit 313. Acquisition unit 312 acquires data read/write requests that are output irregularly by computer 10. If acquisition unit 312 acquires a data rewrite request, selection unit 313 selects, from a plurality of memories 303, the memory 303 to execute data rewrite processing that is the subject of the request. The procedure by which selection unit 313 selects memory 303 in data-processing system 3 is the same as the procedure by which selection unit 113 selects data-processing device 12 in data-processing system 1. Selection unit 313 requests data rewrite processing to memory controller 304 that corresponds to the selected memory 303. Each memory controller 304 causes corresponding memory 303 to perform data rewriting in response to a data rewrite processing request delivered irregularly from selection unit 313.

According to data-processing system 3, computer 10 can use a data storage device 30 comprising a plurality of memories 303 as an external storage device. When data rewriting is carried out in data storage device 30, in addition to wear levelling in individual memories 303, wear levelling is also carried out between memories 303; thus, data rewrite processing is not concentrated in a specific memory 303, and a problem is avoided in which specific memory 303 becomes unusable earlier than other memories 303. As a result, high performance of data-processing system 3 is maintained for a long period of time.

It is also possible to adopt a configuration in which a processor such as a CPU that can execute ordinary data processing is employed as processor 301, and processor 301 generates data rewrite processing requests in accordance with a program stored in one of memories 303, for example. In this case, acquisition unit 312 acquires a request for data rewrite processing of data generated by processor 301.

### MODIFIED EXAMPLES

Each of the above-described embodiments may be modified in a variety of different ways within the scope of the technical concept of the present invention. Examples of these modified examples are shown below. Moreover, two or more of the above-described embodiments and the modified examples shown below may be combined.

(1) In the above-described first to third embodiments, status data shows an indicator (average rewrite rate and defective page rate are examples thereof) obtained by processing the number of data rewrites and the number of defective pages in memory 103 (first embodiment), memory 203 (second embodiment) or memory 303 (third embodiment) (hereafter, memory 103, memory 203 and memory 303 are collectively referred to simply as “memory”). As an alternative to this configuration, status data may also show the number of data rewrites and the number of defective pages in a memory without making modifications. In this case, for example, it is possible to adopt a configuration in which processor 101 (first embodiment or second embodiment) or processor 301 (third embodiment) (hereafter, processor 101 and processor 301 are collectively referred to simply as “processors”) calculate the indicators average rewrite rate and defective page rate using the number of data rewrites and number of defective pages shown in status data, and using these calculated indicators, selection unit 113 (first embodiment or second embodiment) or selection unit 313 (third embodiment) (hereafter, selection unit 113 and selection unit 313 are collectively referred to simply as “selection unit”) select data-processing device 12 (first embodiment), data storage device 20 (second embodiment) or memory 303 (third embodiment) (hereafter, these devices are collectively referred to as “selectable devices”).

(2) In the above-described first to third embodiments, wear levelling is carried out in each of the memories by memory controller 104 (first embodiment), memory controller 204 (second embodiment) or memory controller 304 (third embodiment) (hereafter, memory controller 104, memory controller 204 and memory controller 304 are collectively referred to simply as “memory controllers”). As an alternative, it is also possible to adopt a configuration in which memory controllers do not perform wear levelling in their respective memories.

(3) In the above-described first to third embodiments, average rewrite rate and defective page rate shown by status data are, as explained above, examples of an indicator that indicates the number of data rewrites in a memory and an indicator that indicates the number of data read/write errors, but it is also possible to employ other indicators that show a remaining amount of time for which a memory can be used.

For example, if the number of possible rewrites is approximately the same for each memory, the average number of rewrites may be used in place of the average rewrite rate. Moreover, if the number of pages is approximately the same in each memory, for example, a number of defective pages may be used in place of a defective page rate. It is also possible, for example, for the memory controller to constitute the memory management table (FIG. 13) so as to manage the error rate for a predetermined period in the past (for example, the value obtained by dividing the number of rewrite errors by the number of rewrites) for pages that are not yet deemed defective but in which rewrite errors occur infrequently, and to use, in place of or in addition to the defective page rate, the error rate.

(4) In the above-described first to third embodiments, when the selection unit selects an eligible device, it is possible to adopt a configuration in which, in addition to status data that shows memory usage status, parameters other than memory usage status are used.

For example, it is possible to adopt a configuration in which, when the selection unit 113 selects a data-processing device 12 in the first embodiment, priority is given to the selection of a data-processing device 12 equipped with a processor 101 with a high processing capacity, or a data-processing device 12 equipped with a processor 101 having a processing load factor (for example, a value obtained by dividing the current processing load by the maximum processing capacity) that is currently low. In this case, it is unlikely that processing wait time will occur in the selected data-processing device, with the result that data processing as a whole is carried out at a high speed.

In addition, it is also possible to adopt a configuration in which, when selection unit 113 selects the data-processing device 12 in the first embodiment, for example, data-processing device 12 equipped with an input/output interface 105 that currently has a low communication band usage rate is selected with priority; or a configuration wherein selection unit 113 of the second embodiment selects with priority a data storage device 20 (second embodiment) equipped with an input/output interface 205 that currently has a low communication band usage rate. In this case, it is unlikely that communication wait time will occur in data communications between management device 11 and data-processing device 12 or data storage device 20, with the result that data processing as a whole is carried out at a high speed. Various other parameters, such as the number of unused pages or the number of deletable pages in memory, or the length of time that has elapsed since the selection unit last selected a selectable device, may be used in the selection of a selectable device by the selection unit.

(5) In the above-described first embodiment, computer 10-1, which functions as management device 11, does not serve as data-processing device 12. As an alternative to this configuration it is possible to adopt a configuration in which computer 10-1, which functions as management device 11, also functions as one of data-processing devices 12.

(6) In the explanation of the above-described first embodiment, a usage example of data-processing system 1 is presented, in which each of a series of data-processing tasks in accordance with a single application program is assigned in sequence to one of the plurality of data-processing devices 12, and the series of data-processing tasks is carried out at a high speed as a whole. Usage examples of data-processing system 1 are not limited to this usage; for example, it is possible to adopt a configuration in which individual data-processing devices 12 contained in data-processing system 1 are operated as data-processing devices independent of other data-processing devices 12.

(7) In the above-described first embodiment, it is possible to adopt a configuration in which selection unit 113, in accordance with predetermined rules and based on status data 11 acquired by status acquisition unit 111 from each data-processing device 12, selects the data source data-processing device 12 and the data destination data-processing device 12 from a plurality of data-processing devices 12, and output unit 114 outputs, to source data-processing device 12 and/or destination data-processing device 12 selected by selection unit 113, a request to transfer data from the source data-processing device 12 to the destination data-processing device 12.

This modified example is explained below using a specific example. It is assumed, for example, that data-processing device 12-2 is functioning as a Web server device A, and that data-processing device 12-3 is functioning as a Web server device B. In this situation, it is further assumed, for example, that access is concentrated on Web server device A. In this case, selection unit 113 detects that the average rewrite rate of memory 103 shown in the status data of data-processing device 12-2, for example, exceeds, by at least a predetermined threshold value, the average value of the average rewrite rate for memory 103 of all data-processing devices 12. With this detection as a trigger, selection unit 113 selects data-processing device 12-2 as data-processing device 12 from which data is to be moved, and the data-processing device 12 having the lowest average rewrite rate at that point in time (hereafter defined as data-processing device 12-3) is selected as the data-processing device 12 to which data is to be moved.

Output unit 114 outputs, to data-processing device 12-2 and/or data-processing device 12-3, a request to move data from data-processing device 12-2 to data-processing device 12-3. Data-processing device 12-2 and data-processing device 12-3 move data in response to the request output from management device 11. Data processing device 12-3 subsequently takes over (at least partially) the role of web server device A from data-processing device 12-2. As a result, data rewriting between memories 103 of data-processing device 12 is levelled out.

In the present modified example, data that is moved from the source data-processing device 12 to the destination data-processing device 12 may be all movable data that is stored in memory 103 of the source data-processing device 12, or may be a part thereof. There is no restriction to the type of data that is moved; it may also be a program, for example.

(8) In the first to third embodiments, a configuration may be adopted in which selectable devices are grouped into groups, and a selection unit that performs wear levelling between these groups is provided.

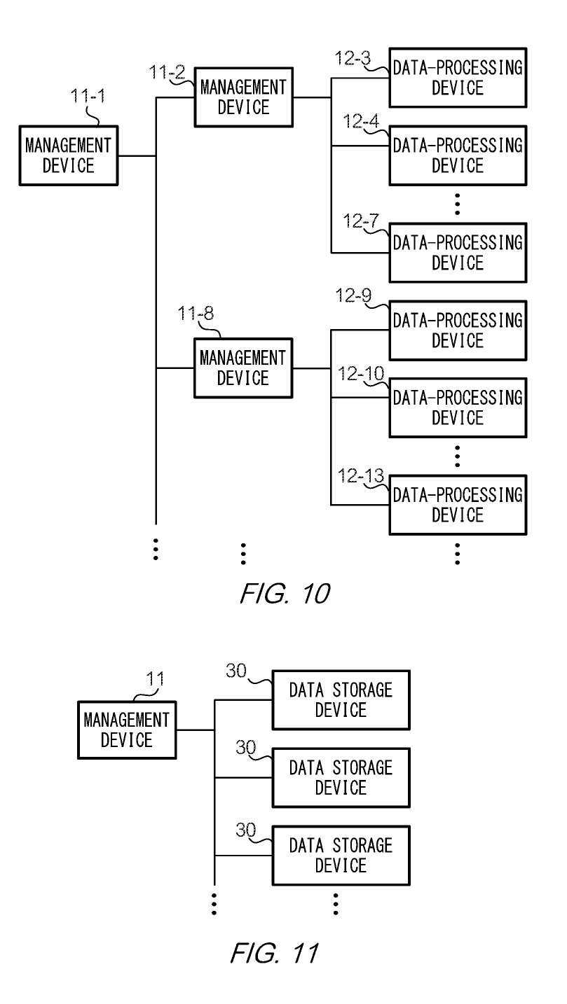

FIG. 10 is a drawing illustrating an idealized configuration of a data-processing system as in the present modified example, obtained by employing the configuration of data-processing system 1 as in the first embodiment, in two stages. In the data-processing system shown in FIG. 10, computers 10-3 to 10-7 function as data-processing devices 12-3 to 12-7, and constitute a first group of data-processing devices 12. Computer 10-2 functions as a management device 11-2 that performs wear levelling between data-processing devices 12-3 to 12-7 that belong to the first group. Computers 10-9 to 10-13 function as data-processing devices 12-9 to 12-13, and constitute a second group of data-processing devices 12. Computer 10-8 functions as a management device 11-8 that performs wear levelling between data-processing devices 12-9 to 12-13 that belong to the second group. In the same way, computer 10-14 and subsequent computers function either as one of management devices 11 that perform wear levelling between data-processing devices 12 that belong to a group, or between data-processing devices 12 that belong to a group. Computer 10-1 functions as management device 11-1 that performs wear levelling between groups of data-processing devices 12.

Each of management devices 11-2, 11-8 . . . , that performs wear levelling between data-processing devices 12 belonging to a group generates status data (hereafter “group status data” that brings together status data (hereafter “memory status data”) pertaining to memory 103 of the data-processing devices 12 belonging to the group managed by said management device. Management device 11-1 acquires status data for each group from management devices 11-2, 11-8 . . . , and based on these status data for each group, selects the group to which the requested data processing is to be assigned. Data processing system 2 as in the second embodiment may also be configured in two stages in the same way.

FIG. 11 is a drawing illustrating an idealized configuration of a data-processing system as in the present modified example, obtained by combining the configuration of data-processing system 2 as in the second embodiment with the configuration of data-processing system 3 as in the third embodiment. In the data-processing system shown in FIG. 11, in place of data storage device 20 provided to data-processing system 2, data storage device 30 provided to data-processing system 3 is used. In the system shown in FIG. 11, processor 301 provided to each of the plurality of data storage devices 30 bring together status data for each memory unit acquired by each of the plurality of memory controllers 304 of the host device, and generates status data for each group. Management device 11 acquires status data for each group from each of the plurality of data storage devices 30, and based on this status data for each group, selects the data storage device 30 to which the requested data rewrite processing is to be allocated.

According to the present modified example, the wear-levelling process between selectable devices is decentralized across a plurality of selection unit; thus, even if the number of memories is increased, the overall performance of the data-processing system is not detrimentally affected.

(9) In the above-described first to third embodiments, formula 1 is presented as a formula for calculating a deterioration indicator that is used by a selection unit in selecting a selectable device, but Formula 1 is an example of a formula for calculating a deterioration indicator, and other formulae may be used as the formula for calculating a deterioration indicator.

(10) In the above-described first and second embodiments, management device 11 is implemented by a general-purpose computer 10 executing a process in accordance with a management device program. In the above-described first embodiment, data-processing device 12 is implemented by a general-purpose computer 10 executing a process in accordance with a data-processing device program. As an alternative, it is also possible to adopt a configuration in which management device 11 and/or data-processing device 12 are implemented in terms of hardware as a so-called dedicated machine.

The management device program as in the above-described first and second embodiments, and the data-processing device program as in the first embodiment may be provided by being downloaded to computer 10 over a network, distributed in the form of a computer-readable recording medium on which these programs are permanently recorded, or in a format that can be read from said recording medium by computer 10.

### EXPLANATION OF REFERENCE SYMBOLS

1 . . . data-processing system, 2 . . . data-processing system, 3 . . . data-processing system, 10 . . . computer, 11 . . . management device, 12 . . . data-processing device, 19 . . . network, 20 . . . data storage device, 30 . . . data storage device, 91 . . . card, 92 . . . chassis, 93 . . . rack, 101 . . . processor, 102 . . . DRAM, 103 . . . memory, 104 . . . memory controller, 105 . . . input/output interface, 106 . . . terminal group, 109 . . . bus, 111 . . . status acquisition unit, 112 . . . request acquisition unit, 113 . . . selection unit, 114 . . . output unit, 121 . . . output unit, 122 . . . acquisition unit, 201 . . . output unit, 202 . . . acquisition unit, 203 . . . memory, 204 . . . memory controller, 205 . . . input/output interface, 301 . . . processor, 303 . . . memory, 304 . . . memory controller, 305 . . . input/output interface, 309 . . . bus, 312 . . . acquisition unit, 313 . . . selection unit

What is claimed is:

1-13. (canceled)

14. A device comprising:
a status acquisition unit that acquires, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing devices;
a request acquisition unit that acquires a data processing request that involves data rewriting;
a selection unit that selects a single data-processing device from the plurality of data-processing devices, in accordance with predetermined rules and based on the status data acquired by the status acquisition unit from each of the data-processing devices; and
an output unit that outputs, to the single data-processing device selected by the selection unit, the data processing request acquired by the request acquisition unit.

15. The device set forth in claim 14, wherein:
the selection unit selects a source data-processing device and a destination data-processing device in accordance with predetermined rules and based on the status data acquired by the status acquisition unit from each of the plurality of data-processing devices; and
the output unit outputs, to the source data-processing device and/or destination data-processing device selected by the selection unit, a request to move data from the source data-processing device to the destination data-processing device.

16. A device comprising:
a memory;
a memory controller that controls data reading/writing in the memory, and that generates status data indicating a status of the memory, including a number of data rewrites to the memory;
an output unit that outputs, to a single device, the status data generated by the memory controller;
an acquisition unit that acquires, from the single device, a data processing request that involves data rewriting to the memory; and
a processor that performs data processing in response to the data processing request acquired by the acquisition unit.

17. A device comprising:
a status acquisition unit that acquires, from each of a plurality of data storage devices comprising a memory, and a memory controller that controls reading/writing of data in the memory and that generates status data indicating a status of the memory, including a number of data rewrites to the memory, the status data generated by the memory controller of each of the plurality of data storage devices;
a request acquisition unit that acquires a data rewrite processing request;
a selection unit that selects a single data storage device from among the plurality of data storage devices, in accordance with predetermined rules and based on the status data acquired by the status acquisition unit from each of the plurality of data storage devices; and
an output unit that outputs, to the single data storage device selected by the selection unit, the data rewrite processing request acquired by the request acquisition unit.

18. A device comprising:
a memory;
a memory controller that controls reading/writing of data in the memory, and that generates status data indicating a status of the memory, including a number of data rewrites in the memory;
an output unit that outputs the status data generated by the memory controller to a single device; and
an acquisition unit that acquires a data rewrite processing request from the single device;
wherein the memory controller causes data rewrite processing to be performed on the memory in response to the data rewrite processing request acquired by the acquisition unit.

19. The device according to claim 16, wherein:
if the memory controller causes data rewrite processing to be performed on the memory, the memory controller selects a single storage region from a plurality of storage regions of the memory, in accordance with predetermined rules and based on the status data, and the memory controller causes the data rewrite processing to be performed on the single storage region of the memory.

20. A device comprising:
a plurality of memories;
a plurality of memory controllers, each of which is provided so as to correspond to one of the plurality of memories, controls reading/writing of data in the corresponding memory, and generates status data indicating a status of the corresponding memory including a number of data rewrites in the corresponding memory;
an acquisition unit that acquires a data rewrite processing request; and
a selection unit that selects a single memory from the plurality of memories in accordance with predetermined rules and based on the status data generated by each of the plurality of memory controllers;
wherein the memory controller corresponding to the single memory selected by the selection unit causes data rewrite processing corresponding to the data rewrite processing request acquired by the acquisition unit to be performed on the single memory.

21. A device set forth in claim 20, wherein:
if each of the plurality of memory controllers causes data rewrite processing to be performed on the memory corresponding to the memory controller, the memory controller selects a single storage region from among a plurality of storage regions of the corresponding memory in accordance with predetermined rules and based on the status data generated by the memory controller, and each of the plurality of memory controllers causes the data rewrite processing to be performed on the single storage region of the corresponding memory.

22. A program stored on a non-transitory computer readable medium, the program for causing a computer to perform:
a process for acquiring, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing device;
a process for acquiring a data processing request that involves data rewriting;
a process for selecting a single data-processing device from among the plurality of data-processing devices, in accordance with predetermined rules and based on the status data acquired from each of the plurality of data-processing devices; and
a process for outputting the data processing request to the single data-processing device.

23. A program stored on a non-transitory computer readable medium, the program for causing a computer to perform:
a process for acquiring, from each of a plurality of data storage devices comprising a memory, a memory controller that controls data reading/writing in the memory and that generates status data indicating a status of the memory including a number of data rewrites to the memory, the status data generated by the memory controller of the data storage device;
a process for acquiring a data rewrite processing request;
a process for selecting a single data storage device from among the plurality of data storage devices, in accordance with predetermined rules and based on the status data acquired from each of the plurality of data storage devices; and
a process for outputting the data rewrite processing request to the single data storage device.

24. A non-transitory computer-readable recording medium on which the program set forth in claim 22 is permanently recorded.

25. A method comprising:
a step in which a single device acquires, from each of a plurality of data-processing devices comprising a memory, a memory controller that controls data reading/writing in the memory and that generates status data indicating a status of the memory including a number of data rewrites to the memory, and a processor that performs data processing, the status data generated by the memory controller of the data-processing device;
a step in which the single device acquires a data processing request that involves data rewriting;
a step in which the single device selects a single data-processing device from among the plurality of data-processing devices, in accordance with predetermined rules and based on the status data acquired from each of the plurality of data-processing devices; and
a step in which the single device outputs the data processing request to the single data-processing device.

26. A method comprising:
a step in which a single device acquires, from each of a plurality of data storage devices comprising a memory, and a memory controller that controls data reading/writing in the memory and that generates status data indicating a status of the memory including a number of data rewrites to the memory, the status data generated by the memory controller of the data storage device;
a step in which the single device acquires a data rewrite processing request;
a step in which the single device selects a single data storage device from among the plurality of data storage devices, in accordance with predetermined rules and based on the status data acquired from each of the plurality of data storage devices; and
a step in which the single device outputs the data rewrite processing request to the single data storage device.
